(19) United States
(12) Patent Application Publication
(10) Pub. No.: US 2009/0250935 A1
(43) Pub. Date: Oct. 8, 2009

(54) ROTOR FOR WIND TURBINE AND ASSEMBLING METHOD THEREOF

(75) Inventors: Doo-hoon Kim, Chungcheongnam-do (KR); Ji-yoon Ryu, Chungcheongnam-do (KR); Jin-su Hwang, Chungcheongbuk-do (KR)

Correspondence Address: OBLON, SPIVAK, MCCLELLAND MAIER & NEUSTADT, P.C., 1940 DUKE STREET, ALEXANDRIA, VA, 22314, US

(73) Assignee: UNISON CO., LTD., CHUNGCHEONGNAM-DO (KR)

(21) Appl. No.: 11/913,616

(22) PCT Filed: Apr. 9, 2007
(86) PCT No.: PCT/KR07/01712

§ 371 Date: Nov. 5, 2007

(30) Foreign Application Priority Data
Apr. 14, 2006 (KR) 10-2006-0034150

(51) Int. Cl. H02K 1/28; F03D 9/00; H02K 15/03

(52) U.S. Cl. 290/55; 310/156.38; 29/598

(57) ABSTRACT

Disclosed is a rotor for a wind turbine, which prevents permanent magnets from being separated from the rotor due to the melting of portions of the permanent magnets bonded to the rotor by a high temperature atmosphere without burying the permanent magnets in the rotor. The rotor includes a circular body provided with grooves having a trapezoidal shape, horizontally formed in the outer circumferential surface of the circular body, and spaced at regular intervals, the central portion of the circular body being connected to a rotary shaft; permanent magnets having a trapezoidal shape and detachably inserted horizontally into the grooves; and fixing rings detachably installed respectively on the front and rear surfaces of the circular body so as to be closely attached to the front and rear surfaces of the permanent magnets to fix the permanent magnets.

### TECHNICAL FIELD

The present invention relates to a rotor for a wind turbine, and more particularly to a rotor for a wind turbine having a simple structure, which prevents permanent magnets from being separated from the rotor due to the melting of portions of the permanent magnets bonded to the rotor by a high temperature atmosphere without burying the permanent magnets in the rotor.

### BACKGROUND ART

Generally, wind turbines employ a method for operating a generator using the rotary power of a windmill, which is rotated by natural wind.

A wind turbine includes a rotary main body installed at the upper end of a strut fixedly installed at a designated height above the ground and rotated in the direction of wind, a windmill having rotating blades installed at the front end of the rotary main body, a stator connected to the windmill by a rotary shaft and installed at the rear end of the windmill, and a rotor installed in the stator and connected to the rotary shaft.

The rotor is rotated in the stator according to the rotation of the rotary shaft, and induces the generation of electricity. Permanent magnets are installed on the outer circumferential surface of the rotor. Here, the permanent magnets are bonded to the outer circumferential surface of the rotor using an adhesive, or are completely buried in the rotor.

The above-described conventional wind turbine has several problems, as follows.

When the rotor is rotated at a high speed and the stator around the rotor has an increased inner temperature so that the rotor becomes in a high temperature atmosphere, the bonding portions of the permanent magnets are melted and thus the permanent magnets may be detached from the rotor during the rotation of the rotor, thus being damaged.

Further, in case that the permanent magnets are buried in the rotor, the rotor has improved safety. However, in this case, the manufacture of the rotor and the repair of the rotor due to malfunctions, and the amendment and alteration of the rotor are difficult and require a long time.

Since the permanent magnets are installed on the rotor, when the rotor is assembled with or disassembled from the stator, the outer circumferential surface of the rotor is attached to the inside of the stator made of metal by the strong attractive force due to the magnetism of the permanent magnets, and thus the assembly of the rotor with the inside of the stator is difficult and complicated.

### DISCLOSURE

### Technical Problem

Therefore, the present invention has been made in view of the above problems, and it is an object of the present invention to provide a rotor for a wind turbine having a simple structure, which prevents permanent magnets from being separated from the rotor due to the melting of portions of the permanent magnets bonded to the rotor by a high temperature atmosphere without burying the permanent magnets in the rotor.

It is another object of the present invention to provide a rotor for a wind turbine, which prevents permanent magnets from being damaged when the permanent magnets are installed on the rotor, is simply assembled, and protects the permanent magnets when the rotor is assembled.

It is another object of the present invention to provide a rotor for a wind turbine, a circular body of which has a light weight and a simple structure.

It is another object of the present invention to provide a rotor for a wind turbine, a circular body of which has an improved solidity.

It is yet another object of the present invention to provide a rotor for a wind turbine, which is efficiently assembled with the inside of a stator under the condition that the assembly of the rotor with stator is not interfered by the strong attractive force of the magnetism of permanent magnets.

### Technical Solution

In accordance with an aspect of the present invention, the above and of the objects can be accomplished by the provision of a rotor for a wind turbine, comprising a circular body provided with grooves having a trapezoidal shape, horizontally formed in the outer circumferential surface of the circular body, and spaced at regular intervals, the central portion of the circular body being connected to a rotary shaft; permanent magnets having a trapezoidal shape and detachably inserted horizontally into the grooves; and fixing rings detachably installed respectively on the front and rear surfaces of the circular body so as to be closely attached to the front and rear surfaces of the permanent magnets to fix the permanent magnets.

The rotor may further comprise magnet housings having a trapezoidal shape, each of which is provided with a receiving groove having a trapezoidal shape and formed in the upper surface of the magnetic housing so as to receive the corresponding one of the permanent magnets, and inserted into the grooves.

The circular body includes a hollow shaft connected to the rotary shaft; a circular plate attached to the outer circumferential surface of the hollow shaft; and a cylindrical member provided with the grooves and attached to the outer circumferential surface of the circular plate.

The circular body may further include a plurality of through holes formed through the circular plate.

The circular body may further include a plurality of support ribs attached between the front surface of the circular plate and the inner circumferential surface of the cylindrical member and between the rear surface of the circular plate and the inner circumferential surface of the cylindrical member.

The circular body may further include a plurality of fixing ribs attached between the front surface of the circular plate and the outer circumferential surface of the hollow shaft and between the rear surface of the circular plate and the outer circumferential surface of the hollow shaft.

In accordance with another aspect of the present invention, there is provided a method for assembling a rotor for a wind turbine comprising installing a fixing ring on the circumference of the rear surface of a circular body of the rotor corresponding to trapezoidal grooves formed in the outer circumferential surface of the circular body; installing the circular body on a stator under the condition that the circular body is disposed in the stator; inserting trapezoidal magnet housings having permanent magnets, attached thereto, into the trapezoidal grooves of the circular body such that the rear surfaces of the permanent magnets are attached to the fixing ring installed on the rear surface of the circular body; and installing another fixing ring on the circumference of the front surface of the circular body such that the front surfaces of the permanent magnets are attached to the fixing ring installed on the front surface of the circular body.

### DESCRIPTION OF DRAWINGS

The above and other objects, features and other advantages of the present invention will be more clearly understood from the following detailed description taken in conjunction with the accompanying drawings, in which:

FIG. 1 is a perspective view of an essential portion of a wind turbine in accordance with the present invention;

FIG. 2 is a schematic longitudinal-sectional view of the wind turbine in accordance with the present invention;

FIG. 3 is a partially exploded perspective view of an essential portion of a rotor for the wind turbine in accordance with the present invention;

FIG. 4 is a front view of the rotor in accordance of the present invention in an assembled state;

FIG. 5 is a longitudinal-sectional view of the rotor of FIG. 4;

FIG. 6 is an enlarged view of the portion “A” of rotor of FIG. 4; and

FIG. 7 is a flow chart for illustrating a method for assembling the rotor in accordance with the present invention.

### BEST MODE

Now, a preferred embodiment of the present invention will be described in detail with reference to the annexed drawings.

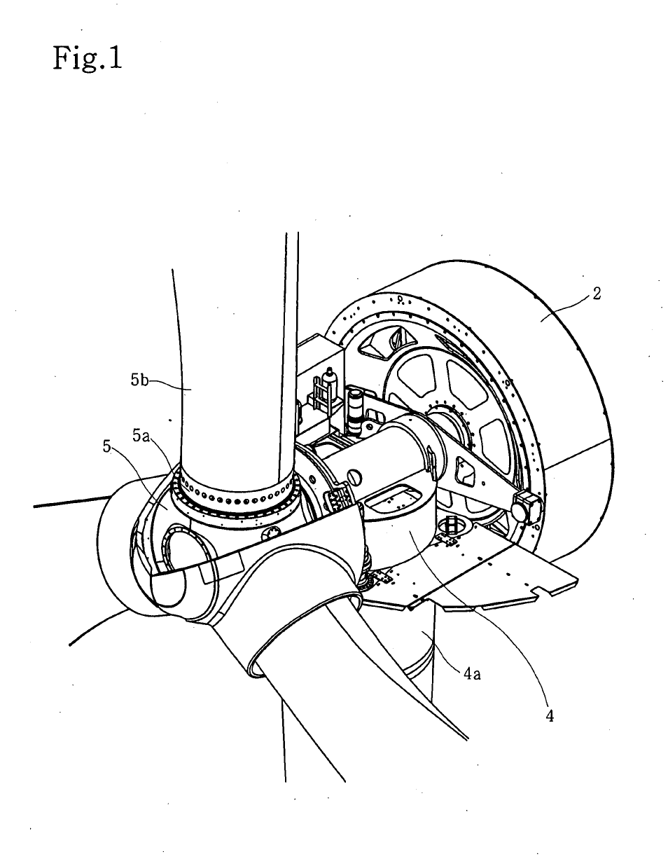

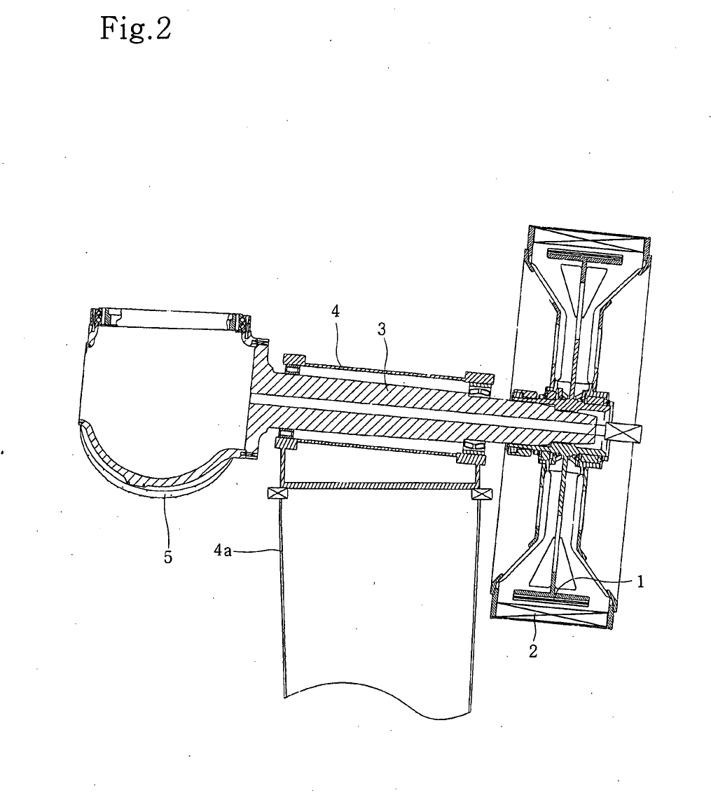

FIG. 1 is a perspective view of an essential portion of a wind turbine in accordance with the present invention, and FIG. 2 is a schematic longitudinal-sectional view of the wind turbine in accordance with the present invention.

As shown in FIGS. 1 and 2, a wind turbine includes a rotor 1 serving as a means of generating electricity, a stator 2, into which the rotor 1 is inserted, a rotary shaft 3, on which the rotor 1 is installed, a rotary main body 4 having a supporter 4a, which rotatably supports the rotary shaft 3 and is inserted into the upper end of a strut, and rotated in the direction of wind, and a windmill 5 installed on the upper end of the rotary main body 4 and having blade fixing units 5a, to which rotating blades 5b are fixed.

In the above wind turbine, as the rotary main body 4 is rotated in the direction of wind, the rotating blades 5b fixed to the blade fixing units 5a are rotated by wind, and thus the windmill 5 having the blade fixing units 5a is rotated. Thereby, the rotary shaft 3, to which the windmill 5 is connected, is rotated.

As the rotary shaft 3 is rotated, the rotor 1 installed at the upper end of the rotary shaft 3 is rotated in the stator 2, thus generating electricity.

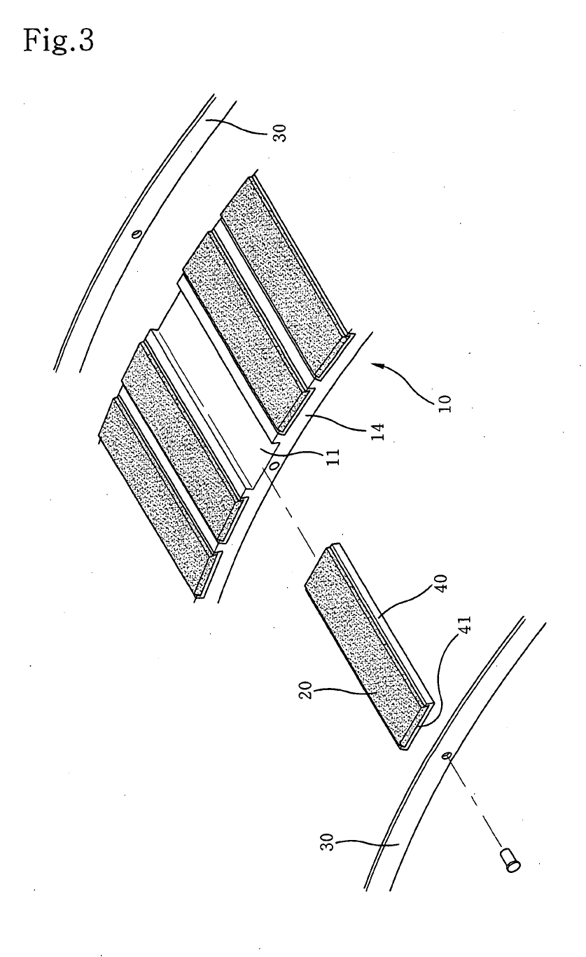

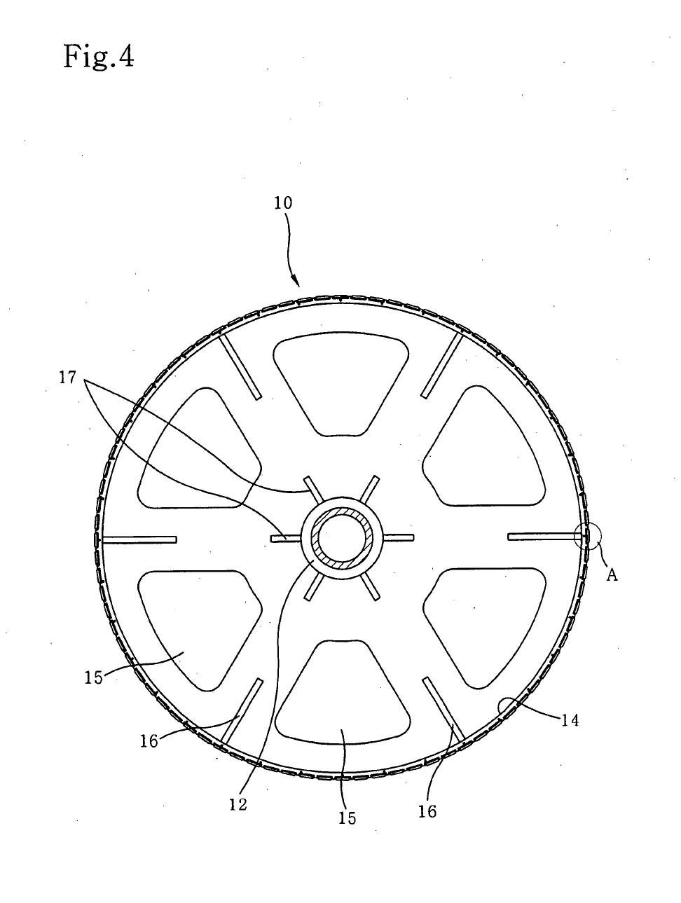

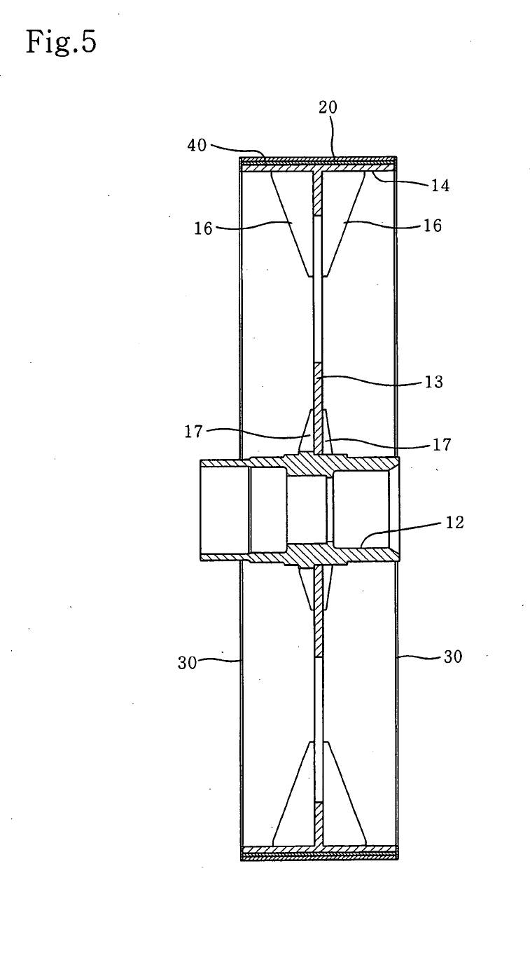

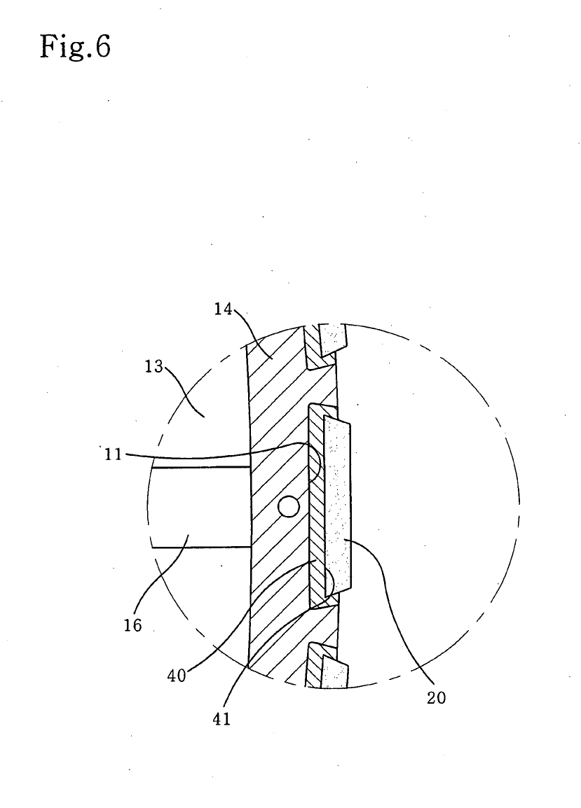

FIG. 3 is a partially exploded perspective view of an essential portion of the rotor in accordance with the present invention, FIG. 4 is a front view of the rotor in accordance of the present invention in an assembled state, FIG. 5 is a longitudinal-sectional view of the rotor of FIG. 4, and FIG. 6 is an enlarged view of the portion “A” of rotor of FIG. 4.

As shown in FIGS. 3 to 6, the rotor 1 includes a circular body 10 provided with grooves 11 formed in the outer circumferential surface thereof, permanent magnets 20 inserted into the grooves 11, fixing rings 30 for fixing the permanent magnets 20, and magnet housings 40 respectively protecting the permanent magnets 20.

The circular body 10 is provided with the grooves 11 having a trapezoidal shape, which are horizontally formed in the outer circumferential surface thereof and spaced at regular intervals, and the central portion of the circular body 10 is connected to the rotary shaft installed on the rotary main body of the wind turbine. Here, the circular body 10 is rotated according to the rotation of the rotary shaft under the condition that the circular body 10 is inserted into the stator.

The circular body 10 includes a hollow shaft 12 connected to the rotary shaft, a circular plate 13 attached to the outer circumferential surface of the hollow shaft 12, a cylindrical member 14 attached to the outer circumferential surface of the circular plate 13 and provided with the grooves 11, a plurality of through holes 15 formed through the circular plate 13, a plurality of support ribs 16 attached between the front surface of the circular plate 13 and the inner circumferential surface of the cylindrical member 14 and between the rear surface of the circular plate 13 and the inner circumferential surface of the cylindrical member 14, and a plurality of fixing ribs 17 attached between the front surface of the circular plate 13 and the outer circumferential surface of the hollow shaft 12 and between the rear surface of the circular plate 13 and the outer circumferential surface of the hollow shaft 12.

The grooves 11 have a trapezoidal shape, and serve to prevent the permanent magnets 20 from being separated from the grooves 11 due to centrifugal force generated in the circumferential direction of the circular body 10, when the magnet housings 40 including the permanent magnets 20 having the same shape as that of the grooves 11 are inserted into the grooves 11.

That is, the grooves 11 serve to horizontally receive the permanent magnets 20 so as to easily assemble the permanent magnets 20 with the circular body 10, and to prevent the permanent magnets 20 from being separated from the grooves 11 in the circumferential direction.

The hollow shaft 12 allows the rotary shaft to be easily connected to the circular body 10, and serves to support the cylindrical member 14 attached to the outer circumference of the circular plate 13 formed around the hollow shaft 12. The cylindrical member 14 is provided with the plurality of the grooves 11, which are spaced at regular intervals and horizontally formed in the outer circumferential surface thereof, so as to assemble the permanent magnets 20 with the circular body 10.

The plurality of through holes 15 are symmetrically formed through the circular plate 13, and serves to reduce the weight of the circular plate 13. The support ribs 16 and the fixing ribs 17 serve to improve solidity between the circular plate 13 and the cylindrical member 14 and between the circular plate 13 and the hollow shaft 12.

The permanent magnets 20 have a trapezoidal shape, and are horizontally inserted into the grooves 11, thus being easily assembled with and disassembled from the cylindrical member 14 of the circular body 10.

The fixing rings 30 are detachably attached to the circumferences of the front and rear surfaces of the cylindrical member 14 of the circular body 10 so as to be closely attached to the front and rear surfaces of the permanent magnets 20, and serve to prevent the permanent magnets 20 from be separated forwardly and backwardly, i.e., horizontally, from the cylindrical member 14.

Each of the magnet housings 40 having a trapezoidal shape is provided with a receiving groove 41 having a trapezoidal shape and formed in the upper surface thereof for receiving the corresponding permanent magnet 20. The magnet housings 40 are horizontally inserted into the grooves 11 under the condition that the permanent magnets 20 are respectively inserted into the receiving grooves 41 of the magnet housings 41, and serve to protect the permanent magnets 20. i.e., to prevent damage to the permanent magnets 20 generated when the permanent magnets 20 are directly inserted into the grooves 11.

Preferably, the permanent magnets 20 and the magnet housings 40 are integrally installed on the circular body 10 under the condition that the permanent magnets 20 are inserted into the receiving grooves 41 of the magnet housings 40, so as to facilitating the manufacture of the rotor of the prevent invention.

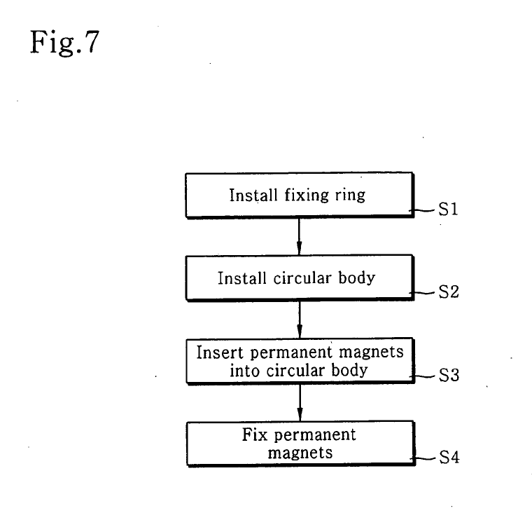

FIG. 7 is a flow chart for illustrating a method for assembling the rotor in accordance with the present invention.

As shown in FIG. 7, the method for assembling the rotor in accordance with the present invention includes installing one fixing ring on the circumference of the rear surface of the circular body of the rotor (S1), installing the circular body in the stator (S2), inserting the permanent magnets into the circular body (S3), and fixing the permanent magnets by another fixing ring (S4). As these steps are sequentially carried out, the rotor is easily assembled with the stator without interference of the strong attractive force due to the magnetism of the permanent magnets.

In the installation of the fixing ring (S1), the fixing ring is installed on the circumference of the rear surface of the circular body corresponding to the trapezoidal grooves formed in the outer circumferential surface of the circular body of the rotor.

That is, before the rotor is installed within the stator, the fixing ring for fixing the permanent magnets is installed in advance on the rear surface of the rotor to be inserted into the stator, so as to facilitate the fixation of the permanent magnets, which will be subsequently carried out.

In the installation of the circular body (S2), the circular body is installed on the stator under the condition that the circular body is disposed within the stator.

Here, the circular body of the rotor is installed within the stator under the condition that the permanent magnets are not installed on the circular body, thereby preventing the installation of the rotor from being interfered by the attractive force of the permanent magnets to metal due to the magnetism of the permanent magnets to facilitate the assembly of the circular body with the stator.

In the insertion of the permanent magnets into the circular body (S3), the trapezoidal magnet housings having the permanent magnets inserted thereinto are inserted into the trapezoidal grooves formed in the outer circumferential surface of the circular body such that the permanent magnets are closely attached to the fixing ring installed on the rear surface of the circular body.

Here, the magnet housings are horizontally inserted into the grooves, so as to firmly assemble the permanent magnets with the circumference of the circular body under the condition that the permanent magnets are not separated from the circular body n the circumferential direction.

In the fixation of the permanent magnets (S4), another fixing ring is installed on the circumference of the front surface of the circular body so as to be closely attached to the front surfaces of the permanent magnets, thus fixing the permanent magnets.

Here, another fixing ring is further installed on the circumference of the front surface of the circular body under the condition that the permanent magnets are inserted into the trapezoidal grooves so as not to be separated from the grooves in the circumferential direction, so as to prevent the permanent magnets from being separated from the grooves in the axial direction, i.e., the horizontal direction, together with the fixing ring installed on the circumference of the rear surface of the circular body, thus completely fixing the permanent magnets into the grooves.

As described above, since the permanent magnets are assembled with the rotor after the rotor is installed within the stator, it is possible to prevent the outer circumferential surface of the rotor from being bonded to the inner surface of the stator due to the strong magnetism of the permanent magnets when the rotor is assembled with the stator.

### INDUSTRIAL APPLICABILITY

As apparent from the above description, the present invention provides a rotor for a wind turbine having a simple structure, which prevents permanent magnets from being separated from the rotor due to the melting of portions of the permanent magnets bonded to the rotor by a high temperature atmosphere without burying the permanent magnets in the rotor, thus being simply manufactured and installed, and preventing damage to the permanent magnets, due to the detachment of the permanent magnets from the rotor during the rotation of the rotor, and a failure of the rotor thereby.

The rotor of the present invention prevents the permanent magnets from being damaged when the permanent magnets are installed on the rotor, causes the permanent magnets to be simply assembled, and protects the permanent magnets when permanent magnets are assembled with the rotor, thus improving the assembling efficiency of the permanent magnets, shortening the time to assembling the permanent magnets with the rotor, and preventing the permanent magnets from being damaged or broken when the permanent magnets are assembled with the rotor so as not to require the replacement of the permanent magnets.

A circular body of the rotor of the present invention has a light weight and a simple structure, thus being simply manufactured and assembled.

The circular body of the rotor of the present invention has an improved solidity, thus not being damaged by external force, such as centrifugal force.

The rotor of the present invention is efficiently assembled with the inside of a stator under the condition that the assembly of the rotor with stator is not interfered by the strong attractive force of the magnetism of the permanent magnets, thus being simply assembled with and disassembled from the stator and shortening the time to assemble the rotor with the stator and disassemble the rotor from the stator.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A rotor for a wind turbine, comprising:
a circular body provided with grooves having a trapezoidal shape, horizontally formed in the outer circumferential surface of the circular body, and spaced at regular intervals, the central portion of said circular body being connected to a rotary shaft;
permanent magnets having a trapezoidal shape and detachably inserted horizontally into the grooves; and
fixing rings detachably installed respectively on the front and rear surfaces of the circular body so as to be closely attached to the front and rear surfaces of the permanent magnets to fix the permanent magnets.

2. The rotor according to claim 1, further comprising magnet housings having a trapezoidal shape, each of which is provided with a receiving groove having a trapezoidal shape and formed in the upper surface of the magnetic housing so as to receive the corresponding one of the permanent magnets, and inserted into the grooves.

3. The rotor according to claim 1, wherein the circular body includes:
a hollow shaft connected to the rotary shaft;
a circular plate attached to the outer circumferential surface of the hollow shaft; and
a cylindrical member provided with the grooves and attached to the outer circumferential surface of the circular plate.

4. The rotor according to claim 3, wherein the circular body further includes a plurality of through holes formed through the circular plate.

5. The rotor according to claim 3, wherein the circular body further includes a plurality of support ribs attached between the front surface of the circular plate and the inner circumferential surface of the cylindrical member and between the rear surface of the circular plate and the inner circumferential surface of the cylindrical member.

6. The rotor according to claim 3, wherein the circular body further includes a plurality of fixing ribs attached between the front surface of the circular plate and the outer circumferential surface of the hollow shaft and between the rear surface of the circular plate and the outer circumferential surface of the hollow shaft.

7. A method for assembling a rotor for a wind turbine comprising:
installing a fixing ring on the circumference of the rear surface of a circular body of the rotor corresponding to trapezoidal grooves formed in the outer circumferential surface of the circular body;
installing the circular body on a stator under the condition that the circular body is disposed in the stator;
inserting trapezoidal magnet housings having permanent magnets, attached thereto, into the trapezoidal grooves of the circular body such that the rear surfaces of the permanent magnets are attached to the fixing ring installed on the rear surface of the circular body; and
installing another fixing ring on the circumference of the front surface of the circular body such that the front surfaces of the permanent magnets are attached to the fixing ring installed on the front surface of the circular body.
